(19) United States
(12) Patent Application Publication
(10) Pub. No.: US 2022/0065393 A1
(43) Pub. Date: Mar. 3, 2022

(54) LOCKING BASE FOR DISPENSERS AND THE LIKE

(71) Applicant: Gilchrist & Soames, Somerset, NJ (US)

(72) Inventors: Matthew Schmitt, Skillman, NJ (US); Joungsu Park, S. Brunswick, NJ (US)

(73) Assignee: Gilchrist & Soames, Somerset, NJ (US)

(21) Appl. No.: 17/009,951

(22) Filed: Sep. 2, 2020

(51) Int. Cl. F16M 13/02; A47K 5/12

(52) U.S. Cl. CPC F16M 13/02; F16M 2200/028; A47K 5/1211

(57) ABSTRACT

Personal use articles such as dispensers are inconspicuously locked and unlocked to a base unit with a mechanical or magnetic key. A projection extends downwardly from the bottom surface of each article, such that when the projection is received by the base unit, the lower surface of the article is seen to be resting upon the upper surface of the base unit, visually obscuring the opening into the base unit. A mechanism captures the projection(s), thereby locking the article to the base unit. The projection may include a peripheral groove, and the mechanism may include a structure that engages with the groove to lock the article to the base unit. The structure may comprise a plunger, a hinged panel with cut-out that engages with the groove, or a panel with a shaped opening that slides within the base unit.

### FIELD OF THE INVENTION

This invention relates generally to personal care and, more particularly, to an inconspicuous, tamper-resistant countertop or vanity-top system including a base unit with a locking coupling for dispensers or other personal-use items.

### BACKGROUND OF THE INVENTION

The hospitality industry is a broad category within the service industry that includes hotels and lodging, food and drink service, event planning, theme parks, transportation, cruise lines, travel, and tourism in general. In bath and restroom areas in particular, it is now common to have refillable containers with shampoo, conditioners, lotions, etc., and various other articles for consumer use. Such personal use items, which may be provided on the tops of counters of vanities, typically require temporary removal for refilling or replacement. It is a challenge to design and provide refillable dispensers and the like that adequately meet the simultaneous desirable characteristics of being attractive, unobtrusive, easily maintained and tamper-resistant.

One solution to this problem is described in U.S. Pat. No. 5,350,087, entitled “Secured disposable liquid soap dispenser.” A base unit, permanently affixed to a countertop, includes a locking mechanism with at least one lug orifice. A bottle for storing liquid soap includes a lug extending from the bottle. The lug on the bottle is received in the lug orifice of the base unit and releasably engaged by a locking mechanism therein. A key or series of movements which are not readily obvious to a casual user of the product are required in order to remove the fluid dispensing unit from the base unit.

While the above purports to be inconspicuous, the use of an open orifice has certain drawbacks. For one, it may be readily apparent to determine how the system unlocks, prompting a user to insert a makeshift key into the orifice. Further, being on a countertop, the orifice may become exposed to water or other substances, resulting in cleaning or sanitary issues. Accordingly, the need remains for a more elegant solution to locking countertop article coupling.

### SUMMARY OF THE INVENTION

This invention is directed to a station for personal use articles wherein one, two or more such articles are locked and unlocked to a base unit with a key. In the preferred embodiment, the coupling between each article and the base unit, as well as the key operation, are visually inconspicuous.

Each personal use article has a top portion and a bottom surface defining an area. A projection, extending downwardly from the bottom surface, defines a cross-sectional area that is less than the area of the bottom surface itself. The base unit has an upper surface with an opening that is larger than the cross-sectional area of the projection but small than the area defined by the bottom surface of the article, such that when the projection is received within the cavity, the lower surface of the article is seen to be resting upon the upper surface of the base unit, visually obscuring the opening into the base unit. A mechanism has a first position wherein the appendage is captured by the base unit, thereby locking the article to the base unit, and a second position wherein the article is unlocked from the base unit. A key is used to switch the mechanism between the first and second positions.

In preferred embodiments the projection includes a peripheral groove, and the mechanism includes a structure that engages with the groove to lock the article to the base unit.

The structure that engages with the groove to lock the article to the base unit may include a spring-biased plunger, and the key may cause the spring-biased plunger to retract from the groove to release the article from the base unit. The key coupling may be mechanical, or the key may use magnetism to cause the spring-biased plunger to retract from the groove to release the article from the base unit. The peripheral groove may be discontinuous, such that the article is rotated to cause the spring-biased plunger to engage with the groove and lock the article from the base unit.

In a different embodiment the upper surface of the base unit includes a hinged panel with cut-out forming the structure that engages with the groove to lock the article to the base unit, such that in the first position, the hinged panel is closed and the cut-out engages with the groove, and in the second position, the hinged panel is open, releasing the article from the base unit. The key may operate a latch that permits and prevents the hinged panel from opening and closing. The latch may be mechanically or magnetically operated by the key.

As a further alternative, the structure that engages with the groove in the projection may comprise a sliding panel within the base unit. The sliding panel may include an aperture having a smaller opening with an edge that engages with the groove to lock the article to the base unit, and wherein the smaller opening transitions to a larger opening defining an area greater than the cross-sectional area defined by the projection. Thus, the smaller and larger openings in the panel may form a keyhole shape. When the panel is translated to align the larger opening with the projection the article may be removed from the base unit. The sliding panel may feature an outer edge that cooperates with the key to move the panel. For example, the outer edge of the sliding panel may have a plurality of teeth, and the key may turn a gear that engages with the teeth to move the panel.

The article(s) locked to the base unit may comprise containers or dispensers, including pump-operated dispensers. The station may include two or more articles, each with lower projections, and a base unit with respective two openings for each article. The key may simultaneously lock and unlock a plurality of the articles to a common base unit.

### BRIEF DESCRIPTION OF THE DRAWINGS

FIG. 1 is a drawing that shows a pair of dispensers coupled to a base unit adapted for placement on a countertop or vanity;

FIG. 2A illustrates a first step associated with mounting an article to a base unit;

FIG. 2B shows the article inserted into the base unit;

FIG. 2C shows how the article is turned a predetermined angle to lock the article to the base;

FIG. 3A is a detail drawing in partial cross-section depicting the locking mechanism prior to insertion of the article;

FIG. 3B shows the article inserted into the base unit;

FIG. 3C shows how, as the article is rotated, the magnetic lock is retracted;

FIG. 3D illustrates how, following a predetermined rotation of the article, the magnetic lock engages, preventing the article from being removed;

FIG. 4 is an exploded view drawing that illustrates how a base unit may be assembled;

FIG. 5 is a bottom view of a base unit;

FIG. 6 depicts an alternative embodiment including an expanded countertop of vanity platform configured to accommodate additional personal care articles;

FIG. 7A is an oblique view of an alternative embodiment of the invention that uses a translating template to secure a container;

FIG. 7B is an exploded view of the embodiment of FIG. 7A;

FIG. 7C is a view into the base showing the translating template;

FIG. 8A is an oblique view of a further embodiment of the invention that uses a clamshell holder; and

FIG. 8B shows the embodiment of FIG. 8A in an open condition.

### DETAILED DESCRIPTION OF THE INVENTION

This invention relates generally to personal-care articles and, more particularly, to an inconspicuous, tamper-resistant countertop or vanity-top system including a base unit with a locking coupling for dispensers, containers, hospitality items or other articles. The preferred embodiments use a pair of identical or similar manually pump-operated dispensers adapted for refilling with liquids, lotions, gels or the like. For example, one container may dispense shampoo, and the other conditioner. Alternatively, one container may dispense hand soap, and the other hand or body lotion or cream. However, the invention is not limited in terms of the articles used. The articles need not be dispensers, and need not be pump-operated. Thus, as disclosed herein, “dispenser” should be taken to include containers, hospitality items or other personal-use articles. Further, more or fewer than two articles may be locked onto a common base unit, and the ornamental design of the system may differ from the designs shown in the figures.

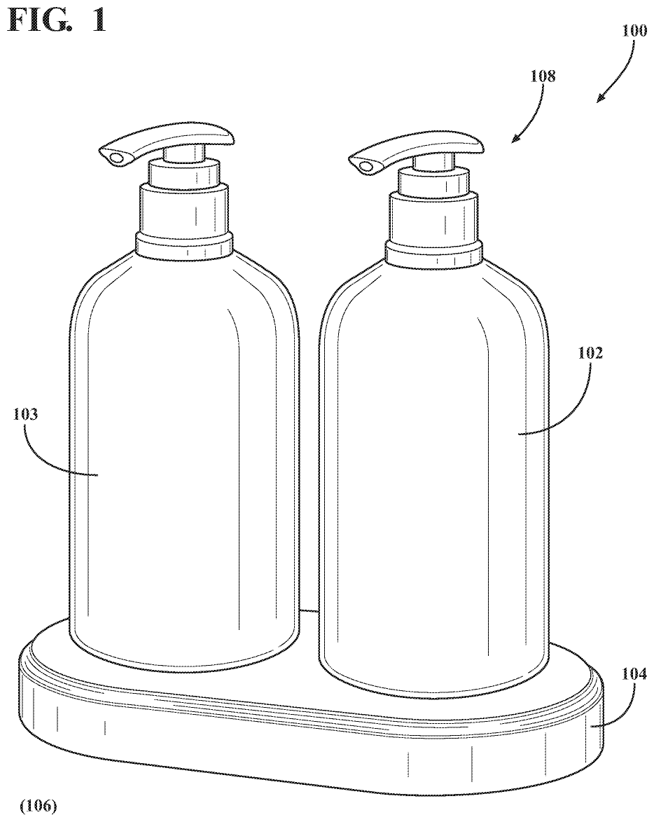

FIG. 1 is a drawing that shows a preferred embodiment of the invention depicted generally at 100. The drawing shows a pair of dispensers 102, 103 coupled to a base unit 104 adapted for placement on a countertop or vanity 106, shower alcove, shelf, etc. In all embodiments, the base unit may be placed onto any surface, or it may be temporarily secured with a lock and key structure, or permanently affixed with an adhesive, double-sided tape, or the like. The base unit and article(s) coupled thereto may be constructed from any suitable materials, including plastics and metal, and may be manufactured through any appropriate process, including molding, stamping, and so forth. Containers 102, 103 may also be made of glass or ceramics.

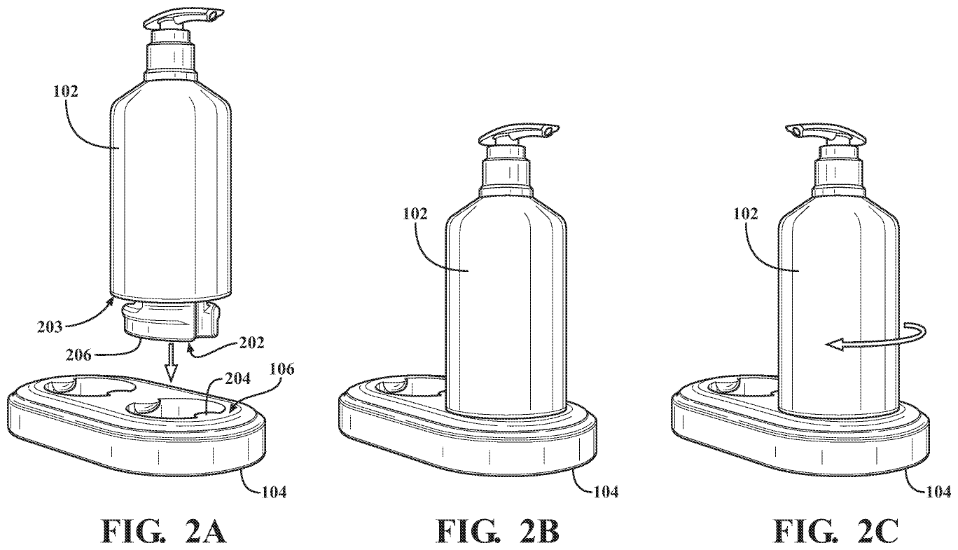

FIGS. 2A-2C illustrate steps associated with coupling an article 102 to base unit 104. FIG. 2A illustrates a first step, wherein vertically oriented grooves 202 on the lower portion of the article are aligned with corresponding tabs 204 on the base unit. While the preferred embodiment utilizes two such grooves and tabs, more or fewer grooves and tabs may alternatively be used. FIG. 2B shows the article 102 inserted into the base unit prior to rotation, and FIG. 2C shows how the article is turned a predetermined angle to lock the article to the base.

In the embodiment shown, the article is rotated ninety degrees to lock the article into position. However, as with the number of vertical grooves and tabs, the degree of rotation is variable as well. Rotations of less or more than ninety degrees may be used as long as the coupling mechanism described in further detail below operates as described. Further, whereas a clockwise rotation is used to lock the article and a counter-clockwise rotation is associated with release, these rotational directions may be reversed through appropriate engineering of the lower, engagement structure of the article.

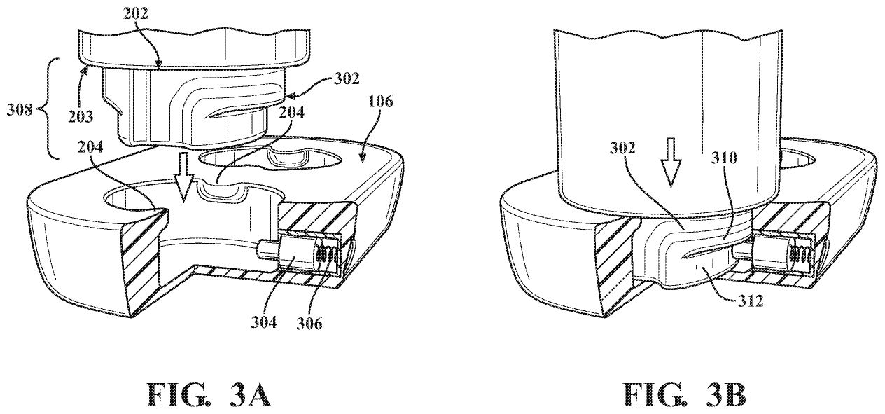

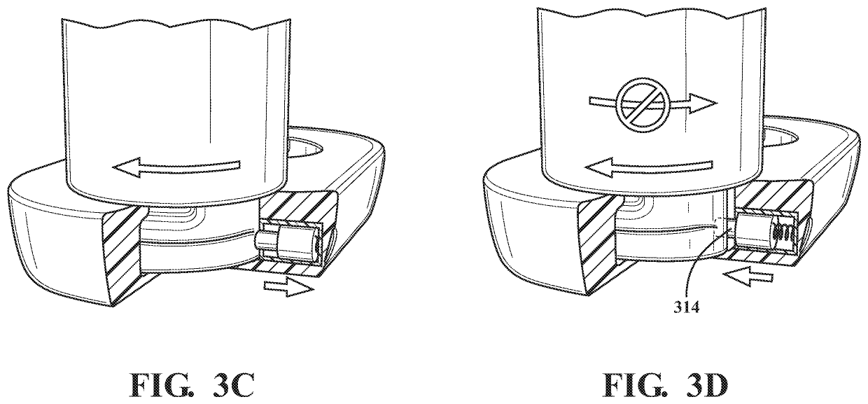

FIG. 3A is a detail drawing in partial cross section depicting the locking mechanism prior to insertion of the article. In all embodiments, the article may comprise a cylindrical container with a lower surface 203 and a circular cross section with a diameter, as shown. In each case, when the article(s) are secured to the base, the bottom surface of each article is flush with the upper surface (i.e., 106) of the base. The engagement structure enters into the base, such that the lower surface of the article or container seems to be “resting on” the base, whereby an observer is unaware that each article or container includes a lower structure that engages with the base unit.

Further, engagement structure 308, extending from the lower surface 203, has an outer periphery or diameter that is smaller that the diameter of the container to more effectively hide the engagement structure when the container(s) are locked into the base. The bottommost surface of the engagement structure is also preferably flat so that the article may rest on a countertop or vanity apart from the base unit during article refilling or changeover.

Continuing the reference to FIG. 3A, vertical grooves (on both sides of engagement structure 308) transition to horizontally oriented annular grooves 302. The horizontal groove is not “threaded” in the sense that it has a “pitch.” In other words, when the article is inserted it is not “screwed into” the base. Rather, the article is simply inserted and turned to lock it into position. In alternative embodiments, however, pitched horizontal grooves may be used, such that the article does advance downwardly upon rotation.

Horizontally oriented annular grooves 302 together comprise an interrupted annular groove proximate to the bottom surface of the container (or other article) to assist with engagement. In other embodiments, as explained in further detail below, this annular groove may be continuous. All embodiments further include some form of post, pin, tab, template or plate that temporarily engages with this annular groove to lock the container of other article(s) in position on a base unit.

FIG. 3A, for example, illustrates a magnetic component 304, biased by spring 306 into the opening into which tabs 204 extend. In this embodiment, the opening is preferably circular, and the path that the magnetic component travels extends radially outwardly from the center of the circle. Magnetic component 304 may be a permanent magnet or a magnetically attractive material such as iron or steel. If a magnet is used, the “key” to unlock the article comprises a magnet of opposite polarity, and if a magnetically attractive material is used, the key may be a magnet of either polarity.

FIG. 3B shows the article inserted into the base unit prior to rotation. Note that a second horizontally oriented groove 312 is formed beneath groove 302 by way of an outwardly extending rib or ridge 310. Note further than when the article is initially inserted into the base unit, the distal end of magnetic component 304 is able to ride against the outer surface of groove 312 as the article is turned. FIG. 3C shows how, as the article is rotated, the magnetic lock remains retracted. However, as shown in FIG. 3D, following a predetermined rotation of the article, the magnetic lock engages, preventing the article from being removed. In particular, at this predetermined angle of rotation, groove 312 ends with an edge 314 defining a depression into which the magnetic component 304 enters, thereby preventing rotation in the opposite direction, preventing removal of the article(s).

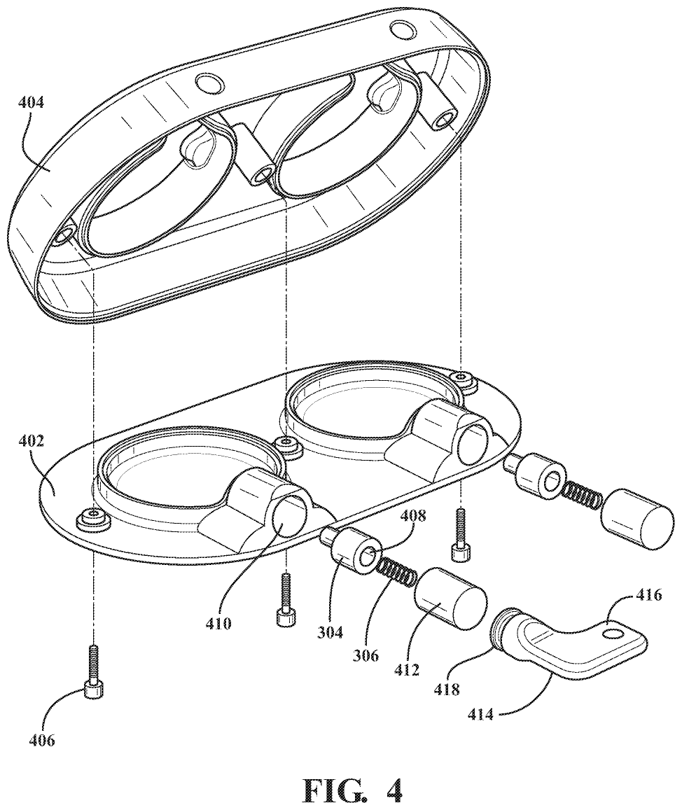

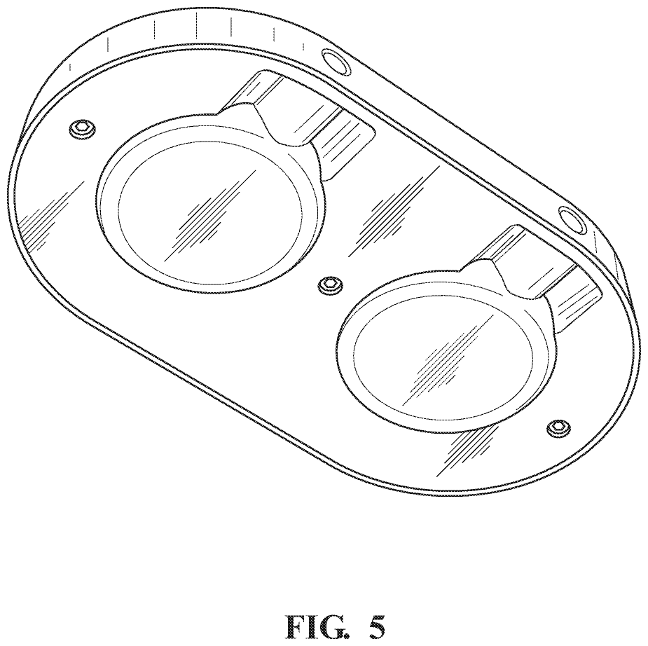

FIG. 4 is an exploded view drawing that illustrates how the base unit is preferably assembled. FIG. 5 is a bottom view of a base unit. The structure is relatively simple, requiring few parts. A lower housing member 402 is received by an upper housing member 404 and secured with screws 406. Magnetic component 304 is received by a bore in lower member 402. Spring 306 is received within a bore 408 in the magnetic component, and plug 412 is press fit into position to retain the spring-biased magnetic component in place.

FIG. 4 also shows a “key” 414 applicable to the invention. While this particular configuration is L-shaped with a hole 416 adapted for use with a key ring, the appearance is not critical as long as the key includes a magnetic component in end 418 operative to retract corresponding magnetic component 304 in the base unit sufficient to facilitate counter-rotation of the captured article for removal. In this embodiment, spring 306 exerts a gentle pressure against magnetic component 304 in the base unit for locking purposes, such that a strong magnetic force is not required for retraction and unlocking. Spring 306 is also preferably stainless steel so as not to interfere with magnetic interactions.

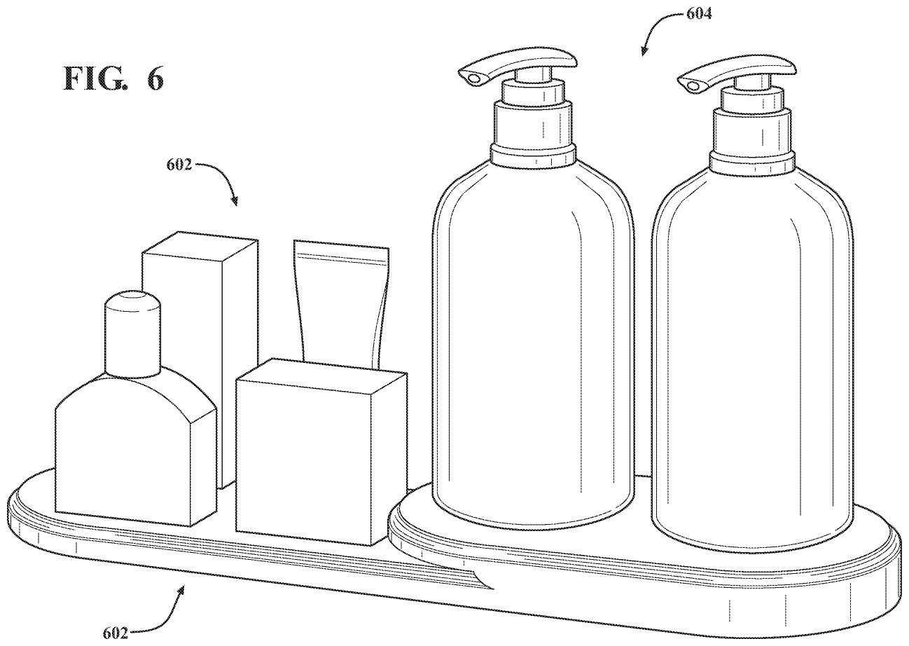

FIG. 6 shows how the base unit 600 may be modified or expanded in any of the embodiments disclosed herein to accommodate additional personal items 602 in combination with one or more articles 604 engaged to a different portion of the base unit, which may include platforms of different heights, as shown.

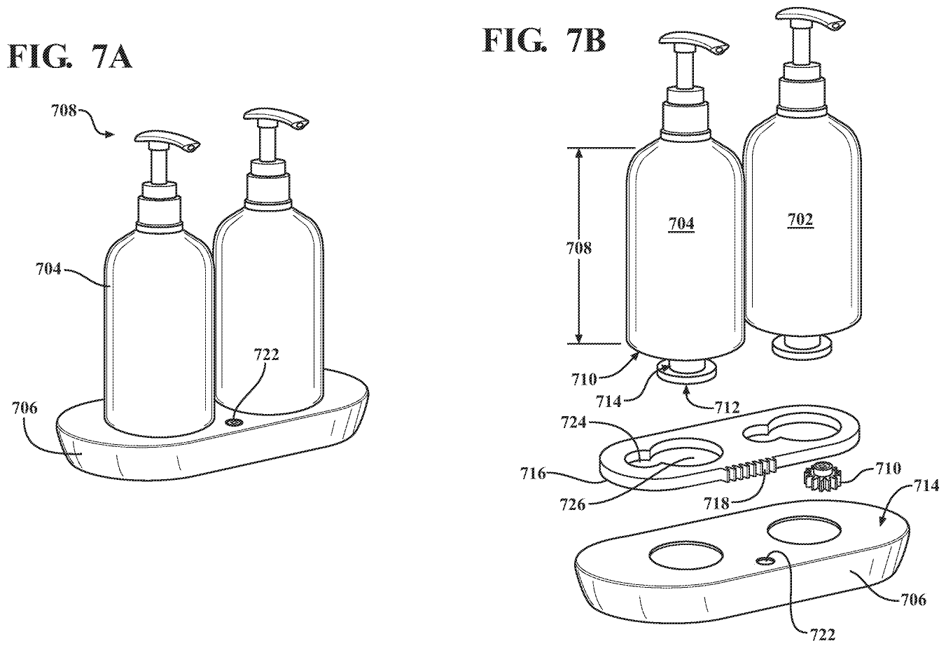

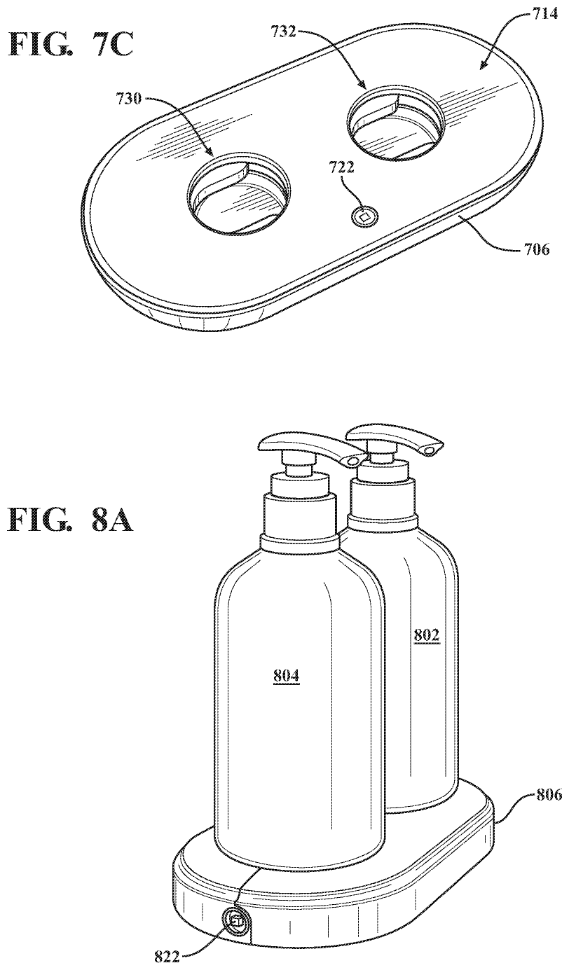

FIG. 7A is an oblique view of an alternative embodiment of the invention that uses a translating template or plate to secure a container or other article. As with all embodiments disclosed herein, while the drawings shows two containers 702, 704 secured to a base 706 more or fewer containers or other articles may be accommodated, and the articles may or may have manual pumps 708. Further, while cylindrical containers are illustrated as example, other shapes maybe used including rectangular, triangular, oval, and so forth.

FIG. 7B is an exploded view of the embodiment of FIG. 7A. Each container comprises a fillable/refillable body portion 708 defining a lower surface 710. As with other embodiments, an engagement structure 712 extends from the lower surface 710, including an annular groove 714 which, in this case, is continuous. Within base unit 706, beneath upper surface 714, is a shaped plate or template 716. The edge of the template 716 includes a section with teeth 718 that engage with the teeth of a gear 720.

Alternatively, a cam or other mechanical linkage can be used in place of a gear. The gear 720 or other linkage is rotated with a key (not shown) that is inserted into a hole 722 formed through the upper surface of base unit 706. When gear 720 is turned with the appropriate key, plate 716 slides laterally, parallel to the plane defined by the base unit.

The plate 716 comprises a keyhole shape associated with each article to be secured. Each keyhole shape includes a smaller through opening 724 and a larger through opening 726. The smaller through opening 724 corresponds to the diameter of annular ring 714, whereas the larger through opening 726 corresponds to the bottommost portion of the engagement structure 712.

As shown in FIG. 7C, the upper surface 714 of the base unit 706 includes aperture(s) 730, 732 to receive a respective engagement structure of each article to be secured. Each aperture is large enough to receive the bottommost portion of the engagement structure 712 of an article when the larger through opening(s) 726 are aligned with are aligned with apertures 730, 732. Once lower surfaces such as 710 rest on the upper surface 714 of the base unit 706, key and gear 720 are turned, causing the plate 716 to slide, such that each smaller through opening 724 engages with the annular groove 714 of an article, locking it onto the base unit. FIG. 7C shows the plate 716 in the locked position even though no article or container has been inserted. To release the containers, the plate 716 is translated in the opposite direction with the key, releasing the engagement structures.

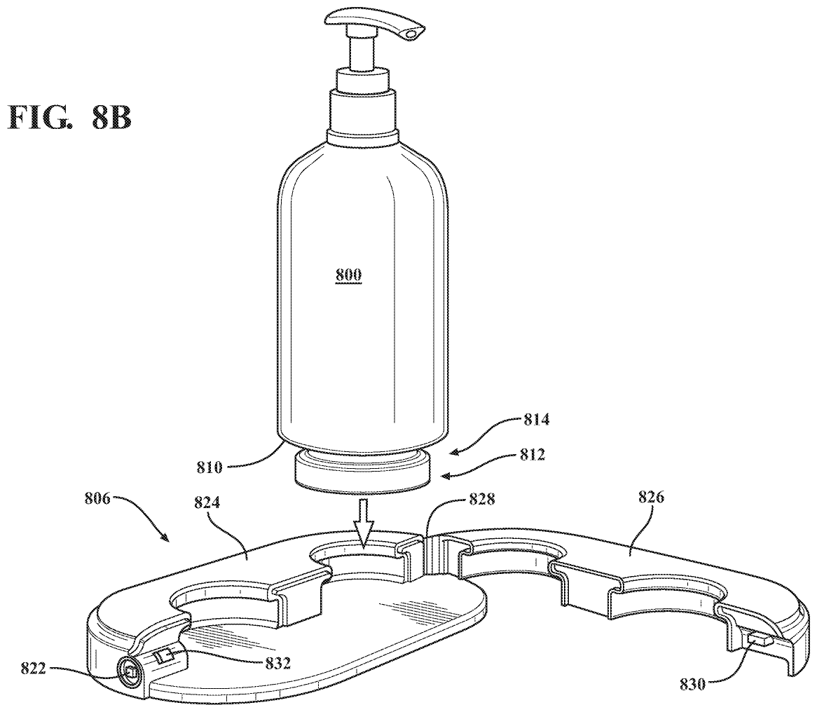

FIGS. 8A, B depict a further embodiment of the invention that uses a clamshell engagement mechanism. FIG. 8A shows two containers 802, 804 secured to a base unit 806, and FIG. 8B shows the embodiment of FIG. 8A in an open condition. The containers may be similar if not identical to those best seen in FIG. 7B. Each container 800 comprises a fillable/refillable body portion defining a lower surface 810. Engagement structure 812 extends from lower surface 810, including an annular continuous groove 814. However, in this embodiment, base unit 806 includes a first portion 824 fixed to base unit 806, and a second portion 826 that opens as shown by pivoting at hinge 828.

The first and second portions each have cut-outs that fits around grooves 814 in article 800. In the preferred embodiment, the cut-out define concave half circles, each with a diameter slightly greater than the diameter of annular groove 814, such that when the first and second portions are closed, each article is secured to the base. When the two halves are closed, a latch engages to keep the two halves together until a key (not shown) interacts with region 822 on the side of the base 806. In the preferred embodiment, the latching mechanism is similar to the mechanism depicted in FIG. 3A. For example, a tab 830 may engage with a spring-biased member once received within hole 832, such that when a magnetic key is brought proximate to region 822, the member releases the tab and allows the two halves to open. It will be appreciated that a mechanical key may alternatively be used to make contact with a moveable member that releases tab 830.

The advantages of the invention are many. As mentioned, when the article(s) are secured to the base unit, the locking mechanism is entirely hidden, and it appears as though the articles are merely resting on the upper surface of the base. Also, particularly in the embodiments that use continuous annular grooves, the articles may be rotated when secured. This may assist with orienting dispensers with pumps, for example.

1. A station for personal use items, comprising:
a personal use article having a top portion and a bottom portion with a bottom surface defining an area;
wherein the bottom portion of the article includes a projection extending downwardly from the bottom surface, and wherein the projection defines a cross-sectional area that is less than the area of the bottom surface;
a base unit having a lower surface and an upper surface, and wherein the upper surface includes an opening into a cavity in the base unit;
wherein the opening in the upper surface of the base unit is larger than the cross-sectional area of the projection but small than the area defined by the bottom surface of the article, such that when the projection is received within the cavity, the lower surface of the article is seen to be resting upon the upper surface of the base unit, visually obscuring the opening into the base unit;
a mechanism having a first position wherein the appendage is captured by the base unit, thereby locking the article to the base unit, and a second position wherein the article is unlocked from the base unit; and
a key for switching the mechanism between the first and second positions.

2. The station of claim 1, wherein the projection includes a peripheral groove; and
the mechanism includes a structure that engages with the groove to lock the article to the base unit.

3. The station of claim 2, wherein the structure that engages with the groove to lock the article to the base unit includes a spring-biased plunger; and
wherein the key causes the spring-biased plunger to retract from the groove to release the article from the base unit.

4. The station of claim 3, wherein the key uses magnetism to cause the spring-biased plunger to retract from the groove to release the article from the base unit.

5. The station of claim 3, wherein the peripheral groove is discontinuous, and the article is rotated to cause the spring-biased plunger to engage with the groove and lock the article from the base unit.

6. The station of claim 1, wherein the upper surface of the base unit includes a hinged panel with cut-out forming the structure that engages with the groove to lock the article to the base unit; and wherein:
in the first position, the hinged panel is closed and the cut-out engages with the groove; and
in the second position, the hinged panel is open, releasing the article from the base unit.

7. The station of claim 1, wherein the key operates a latch permits and prevents the hinged panel from opening and closing.

8. The station of claim 1, wherein the latch is mechanically or magnetically operated by the key.

9. The station of claim 1, wherein the structure that engages with the groove in the projection is a sliding panel within the base unit;
wherein the sliding panel includes an aperture having a smaller opening with an edge that engages with the groove to lock the article to the base unit; and
wherein the smaller opening transition to a larger opening defining an area greater than the cross-sectional area defined by the projection;
whereby, when the panel is translated to align the larger opening with the projection the article may be removed from the base unit.

10. The station of claim 9, wherein the sliding panel has an outer edge that cooperates with the key to move the panel.

11. The station of claim 10, wherein the outer edge of the sliding panel has a plurality of teeth; and
the key turns a gear that engages with the teeth to move the panel.

12. The station of claim 9, wherein the smaller and larger openings in the panel form a keyhole shape.

13. The station of claim 1, wherein the article is a container.

14. The station of claim 1, wherein the article is a dispenser.

15. The station of claim 1, including two articles, each with lower projections, and a base unit with respective two openings for each article; and
wherein the key simultaneously locks and unlocks both articles to the base unit.
